(19) United States
(12) Patent Application Publication
(10) Pub. No.: US 2016/0044444 A1
(43) Pub. Date: Feb. 11, 2016

(54) DETERMINING RANGE IN A WIRELESS SYSTEM

(71) Applicant: QUALCOMM Incorporated, San Diego, CA (US)

(72) Inventors: Zachary David Rattner, San Diego, CA (US); Michael Orlando DeVico, San Diego, CA (US)

(21) Appl. No.: 14/711,838

(22) Filed: May 14, 2015

Related U.S. Application Data
(60) Provisional application No. 62/034,813, filed on Aug. 8, 2014.

(51) Int. Cl. H04W 4/00; H04W 8/00

(52) U.S. Cl. CPC H04W 4/008; H04W 8/005

(57) ABSTRACT

A method includes obtaining a received signal strength indication and processing the received signal strength indication to determine a range between a first device and a second device free of prior configuration data between the first device and the second device.

### RELATED APPLICATIONS

This application claims the benefit of U.S. Provisional Patent Application No. 62/034,813, entitled “Determining Range In A Wireless System,” filed Aug. 8, 2014, the contents of which are hereby incorporated by reference in their entirety.

### DESCRIPTION OF THE RELATED ART

Mobile devices, such as wireless communication devices continue to proliferate. One desirable parameter for mobile devices is the ability to determine a distance of the mobile device to a fixed point or to another mobile device. Small-area wireless systems such as Bluetooth and WIFI use a parameter called the received signal strength indicator (RSSI) for channel establishment and management. The RSSI measurements can also be used as a coarse estimator of the distance between the transmitter and receiver. Traditionally, this approach requires configuration of thresholds, time to trigger, and hysteresis parameters, and results in distance measurements.

However, it would be desirable to be able to determine range or distance between devices in a wireless system without the conventional configuration parameters.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a block diagram illustrating an exemplary embodiment of determining range in a wireless system.

FIG. 2 is a block diagram illustrating an example of a beacon device of FIG. 1.

FIG. 3 is a block diagram illustrating an example of a wireless device, which can be an example of a user device of FIG. 1.

FIG. 4 is an example of a data structure for determining range in a wireless system.

FIGS. 5A and 5B are a flow chart collectively illustrating an exemplary embodiment of a method for determining range in a wireless system.

FIG. 6 is a graph illustrating a number of RSSI measurements for a user device.

FIGS. 7A, 7B, 7C and 7D are graphs illustrating the processing of RSSI measurements for a user device to obtain range information.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “user device” and “client device” include a device that can be capable of receiving content from a web site or server and transmitting information to a website or server. A user device may also be a wearable device that can interact with other user devices, whether or not being connected to, or able to connect to a web site or server. A user device or client device can be a stationary device, a mobile device, a wearable device, or another device. The terms “user device” and “client device” can be used interchangeably.

As used herein, the term “user” refers to an individual using or wearing a user device. In some applications, a user can receive content on a user device or on a client device and can transmit information to a website or server or to another user device.

As used herein, the term “context” refers to any or all attributes of the user or the user device, such as physical, logical, social, historical and other contextual information.

As used herein, the term “proximity” refers to one or more of the location and/or relationship between a user or a user device and its environment, a user or a user device's relationship to another user or another user device or a user or a user device's relationship to another item, device, token, etc.

As used herein, the term “beacon” or “beacon device” refers to a communication device that can communicate wirelessly with a user device or a client device.

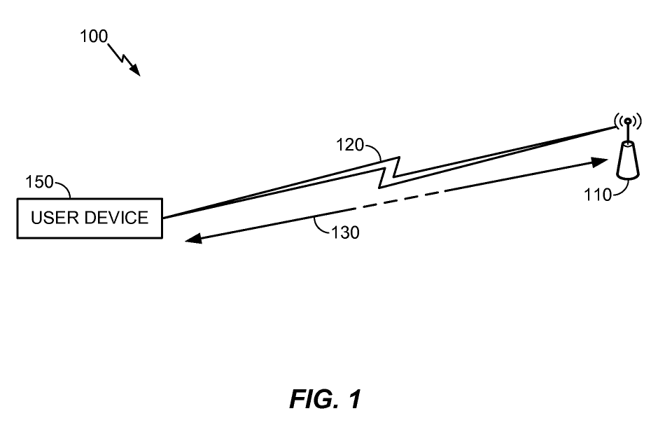

FIG. 1 is a block diagram illustrating an exemplary embodiment of determining range in a wireless system. In an exemplary embodiment, the system 100 comprises a beacon device 110 coupled to a user device 150 over a wireless communication channel 120. In an exemplary embodiment, the beacon device 110 can comprise a fixed beacon device, a mobile beacon device, a tablet computing device, a portable communication device such as a smartphone, or any device capable of wirelessly communicating with the user device 150. In an exemplary embodiment, the wireless communication channel 120 can be a wireless fidelity (WIFI) communication channel, a Bluetooth communication channel, a cellular communication channel, or any other wireless communication channel. In an exemplary embodiment, the user device 150 may comprise a cellular communication device, a WIFI enabled communication device, a Bluetooth enabled communication device, a tablet computing device, or any other wireless device capable of wirelessly communicating with the beacon device 110.

In an exemplary embodiment, the beacon device 110 and the user device 150 exchange information over wireless communication channel 120 that allows range or distance information, illustrated using arrow 130, to be obtained so that the range or distance between the beacon device 110 and the user device 150 can be determined, including, for example only, whether the user device 150 is moving toward the beacon device 110, whether the user device 150 is moving away from the beacon device 110, whether the distance between the user device 150 and the beacon device 110 is constant or is changing, and other range information. In an exemplary embodiment, the range information can be grouped into broad distance categories such as, for example “near” “medium” and “far” with the terms “near” “medium” and “far” being relative to each other. Other range or distance categories may also be implemented.

In an exemplary embodiment, determining the range between the user device 150 and the beacon device 110 requires no prior configuration information between the user device 150 and the beacon device 110. In an exemplary embodiment, the system 100 also may determine rate-of-change information. For example, client applications present on the user device 150 and/or the beacon device 110 can be configured to act on events based on whether the user device 150 may be heading in a particular direction determined by the beacon device 110, whether the user device 150 may be moving toward the beacon device 110 or whether the user device 150 may be moving away from the beacon device 110.

In an exemplary embodiment, a ranging module, which can be implemented as software, firmware, or a combination of software and firmware on the beacon device 110 or on the user device 150, may analyze received signal strength indicator (RSSI) measurements between the user device 150 and the beacon device 110 over time and use that information to categorize the location of the user device 150 into coarse distance categories (e.g., “near” “medium” or “far”) relative to the beacon device 110. In an exemplary embodiment, actual distance need not be calculated. The ranging module accomplishes this by using averaging and mode filtering to mitigate noise in the raw RSSI signal. The ranging module then differentiates the filtered signal to estimate how the user device 150 is moving relative to the beacon device 110 and uses that information to determine when the signal has increased or decreased sufficiently to trigger a state change between, for example, three exemplary range categories arbitrarily referred to as “near” “medium” and “far” and whether the user device 150 is moving toward or away from the beacon device 110.

In an exemplary embodiment, the ranging module determines when a Bluetooth Low Energy (BLE) user device (the BLE user device being the user device 150 in this example) is in proximity of a smartphone, tablet, fixed beacon, or other enabled device (the beacon device 110 in this example). The ranging module determines when the BLE device enters and leaves the proximity of the enabled device on which the ranging module is running.

In an exemplary embodiment, the operation of the ranging module can be extended to quantize the RSSI levels into distance categories (e.g., near, medium, far, etc.). Additionally, rate of change information is determined so client software can be aware of whether the user device is heading toward another distance category. Although the ranging module is described with BLE devices in mind, it uses RSSI measurements and is therefore applicable to other wireless systems, such as, for example only, WIFI, or other wireless technologies.

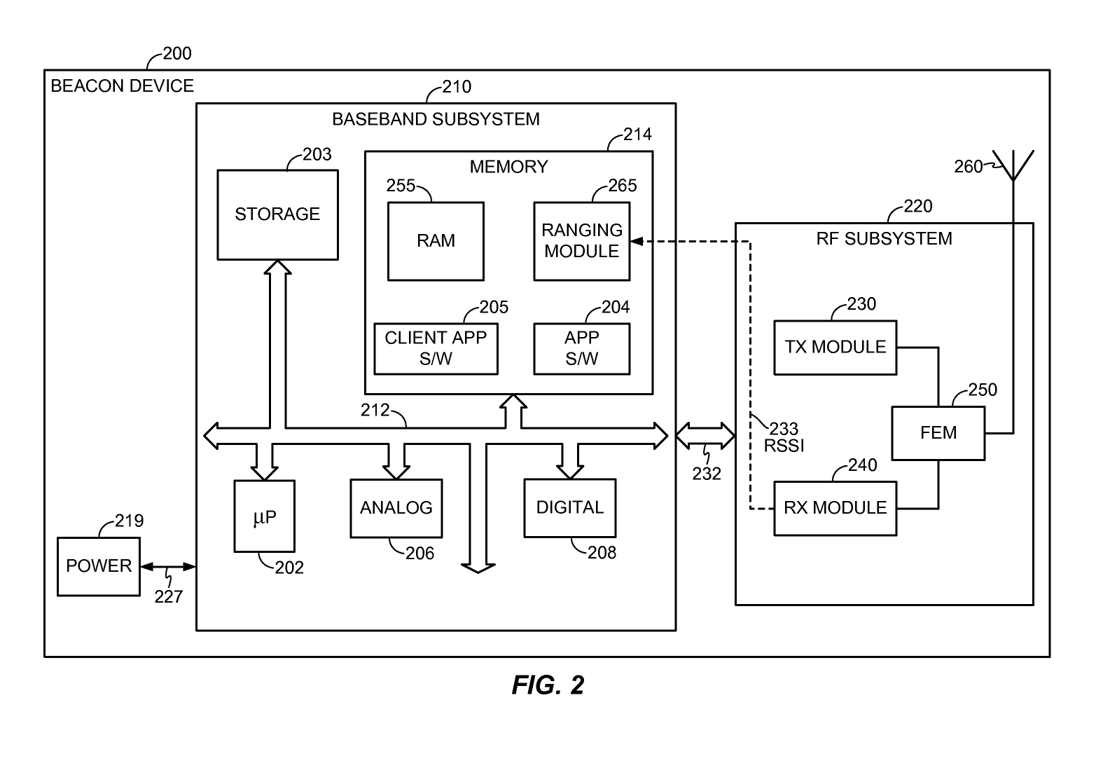

FIG. 2 is a block diagram illustrating an example of a beacon device of FIG. 1. In an exemplary embodiment, the beacon device 200 can be a “Bluetooth” enabled wireless communication device, a portable cellular telephone, a tablet computing device, a WIFI enabled communication device, a fixed beacon, or can be any other communication device. Embodiments of the system for determining range in a wireless system can be implemented in any communication device. The beacon device 200 illustrated in FIG. 2 is intended to be a simplified example of a beacon device and to illustrate one of many possible applications in which determining range in a wireless system can be implemented. One having ordinary skill in the art will understand the operation of a beacon device, and, as such, implementation details are omitted. In an embodiment, the beacon device 200 includes a baseband subsystem 210 and an RF subsystem 220 connected together over a system bus 232. The system bus 232 can comprise physical and logical connections that couple the above-described elements together and enable their interoperability. In an embodiment, the RF subsystem 220 can be a wireless transceiver. Although details are not shown for clarity, the RF subsystem 220 generally includes a transmit module 230 having modulation, upconversion and amplification circuitry for preparing a baseband information signal for transmission, includes a receive module 240 having amplification, filtering and downconversion circuitry for receiving and downconverting an RF signal to a baseband information signal to recover data, and includes a front end module (FEM) 250 that includes diplexer circuitry, duplexer circuitry, or any other circuitry that can separate a transmit signal from a receive signal, as known to those skilled in the art. An antenna 260 is connected to the FEM 250. In an exemplary embodiment, the RF subsystem 220 can be configured for Bluetooth communication, or another wireless communication methodology. A power source 219 can also be coupled to the baseband subsystem 210 over connection 227 to provide power to the beacon device 200. In an exemplary embodiment, the power source 219 can be a rechargeable or disposable battery.

The baseband subsystem 210 generally includes a processor 202, which can be a general purpose or special purpose microprocessor, memory 214, application software 204, analog circuit elements 206, digital circuit elements 208, and storage element 203 coupled over a system bus 212. The system bus 212 can comprise the physical and logical connections to couple the above-described elements together and enable their interoperability.

The memory 214 may also include random access memory 255, ranging module 265, and client application software 205. In an exemplary embodiment, the ranging module 265 may comprise one or more modules, instructions, executable software or firmware, etc., to allow the beacon device 200 to determine range information with respect to one or more user devices using, for example, an RSSI signal provided by the receive module 240 over logical connection 233. The connection 233 is shown in dotted line to indicate that it is a logical connection, whereby the RSSI signal would be transferred from the receive module 240 to the ranging module 265 over the system bus 232 and the system bus 212. In an exemplary embodiment, the client application software 205 may comprise one or more modules, instructions, executable software or firmware, etc., related to a particular application, such as, for example only, software related to location, distance and/or range-dependent application.

The processor 202 can be any processor that executes the application software 204 to control the operation and functionality of the beacon device 200. The processor 202 can also execute the client application software 205 and the ranging module 265. The memory 214 can be volatile or non-volatile memory, and in an embodiment, can be non-volatile memory that stores the application software 204, client application software 205 and the ranging module 265.

The analog circuitry 206 and the digital circuitry 208 include the signal processing, signal conversion, and related logic that convert an input signal to an information signal that is to be transmitted. Similarly, the analog circuitry 206 and the digital circuitry 208 include the signal processing elements used to generate an information signal that contains recovered information from a received signal. The digital circuitry 208 can include, for example, a digital signal processor (DSP), a field programmable gate array (FPGA), or any other processing device. Because the baseband subsystem 210 includes both analog and digital elements, it can be referred to as a mixed signal device (MSD).

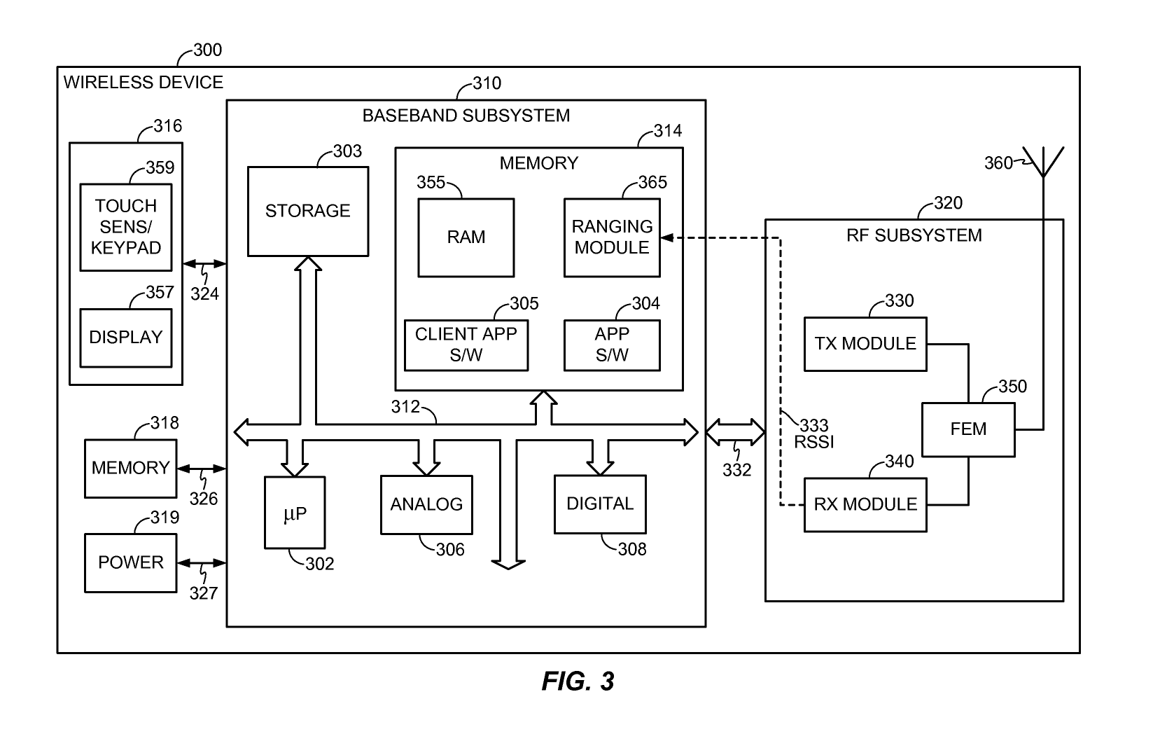

FIG. 3 is a block diagram illustrating an example of a wireless device 300, which can be an example of a user device of FIG. 1. In an embodiment, the wireless device 300 can be a “Bluetooth” wireless communication device, a portable cellular telephone, a WIFI enabled communication device, or can be any other communication device. Embodiments of the system for determining range in a wireless system can be implemented in any communication device. The wireless device 300 illustrated in FIG. 3 is intended to be a simplified example of a cellular telephone and to illustrate one of many possible applications in which the system for determining range in a wireless system can be implemented. One having ordinary skill in the art will understand the operation of a portable cellular telephone, and, as such, implementation details are omitted. In an embodiment, the wireless device 300 includes a baseband subsystem 310 and an RF subsystem 320 connected together over a system bus 332. The system bus 332 can comprise physical and logical connections that couple the above-described elements together and enable their interoperability. In an embodiment, the RF subsystem 320 can be a wireless transceiver. Although details are not shown for clarity, the RF subsystem 320 generally includes a transmit module 330 having modulation, upconversion and amplification circuitry for preparing a baseband information signal for transmission, includes a receive module 340 having amplification, filtering and downconversion circuitry for receiving and downconverting an RF signal to a baseband information signal to recover data, and includes a front end module (FEM) 350 that includes diplexer circuitry, duplexer circuitry, or any other circuitry that can separate a transmit signal from a receive signal, as known to those skilled in the art. An antenna 360 is connected to the FEM 350. In an exemplary embodiment, the RF subsystem 320 can be configured for Bluetooth communication, or another wireless communication methodology.

The baseband subsystem 310 generally includes a processor 302, which can be a general purpose or special purpose microprocessor, memory 314, application software 304, analog circuit elements 306, digital circuit elements 308, and storage element 303 coupled over a system bus 312. The system bus 312 can comprise the physical and logical connections to couple the above-described elements together and enable their interoperability. A power source 319 can also be coupled to the baseband subsystem 310 over connection 327 to provide power to the wireless device 300. In an exemplary embodiment, the power source 319 can be a rechargeable or disposable battery.

An input/output (I/O) element 316 is connected to the baseband subsystem 310 over connection 324, and a memory element 318 is coupled to the baseband subsystem 310 over connection 326. The I/O element 316 can include, for example, a display 357, a touch-sensitive, or other type of keypad 359, a microphone (not shown), a speaker (not shown), a pointing device (not shown), user interface control elements, and any other devices or system that allow a user to provide input commands and receive outputs from the wireless device 300.

The memory element 318 can be any type of volatile or non-volatile memory, and in an embodiment, can include flash memory. The memory element 318 can be permanently installed in the wireless device 300, or can be a removable memory element, such as a removable memory card.

The memory 314 may also include random access memory 355, ranging module 365, and client application software 305. In an exemplary embodiment, the ranging module 365 may comprise one or more modules, instructions, executable software or firmware, etc., to allow the wireless device 300 to determine range information with respect to one or more beacon devices using, for example, an RSSI signal provided by the receive module 340 over logical connection 333. The connection 333 is shown in dotted line to indicate that it is a logical connection, whereby the RSSI signal would be transferred from the receive module 340 to the ranging module 365 over the system bus 332 and the system bus 312. In an exemplary embodiment, the client application software 305 may comprise one or more modules, instructions, executable software or firmware, etc., related to a particular application, such as, for example only, software related to location, distance and/or range-dependent application.

The processor 302 can be any processor that executes the application software 304 to control the operation and functionality of the wireless device 300. The processor 302 can also execute the client application software 305 and the ranging module 365. The memory 314 can be volatile or non-volatile memory, and in an embodiment, can be non-volatile memory that stores the application software 304, client application software 305 and the ranging module 365.

The analog circuitry 306 and the digital circuitry 308 include the signal processing, signal conversion, and logic that convert an input signal provided by the I/O element 316 to an information signal that is to be transmitted. Similarly, the analog circuitry 306 and the digital circuitry 308 include the signal processing elements used to generate an information signal that contains recovered information from a received signal. The digital circuitry 308 can include, for example, a digital signal processor (DSP), a field programmable gate array (FPGA), or any other processing device. Because the baseband subsystem 310 includes both analog and digital elements, it can be referred to as a mixed signal device (MSD).

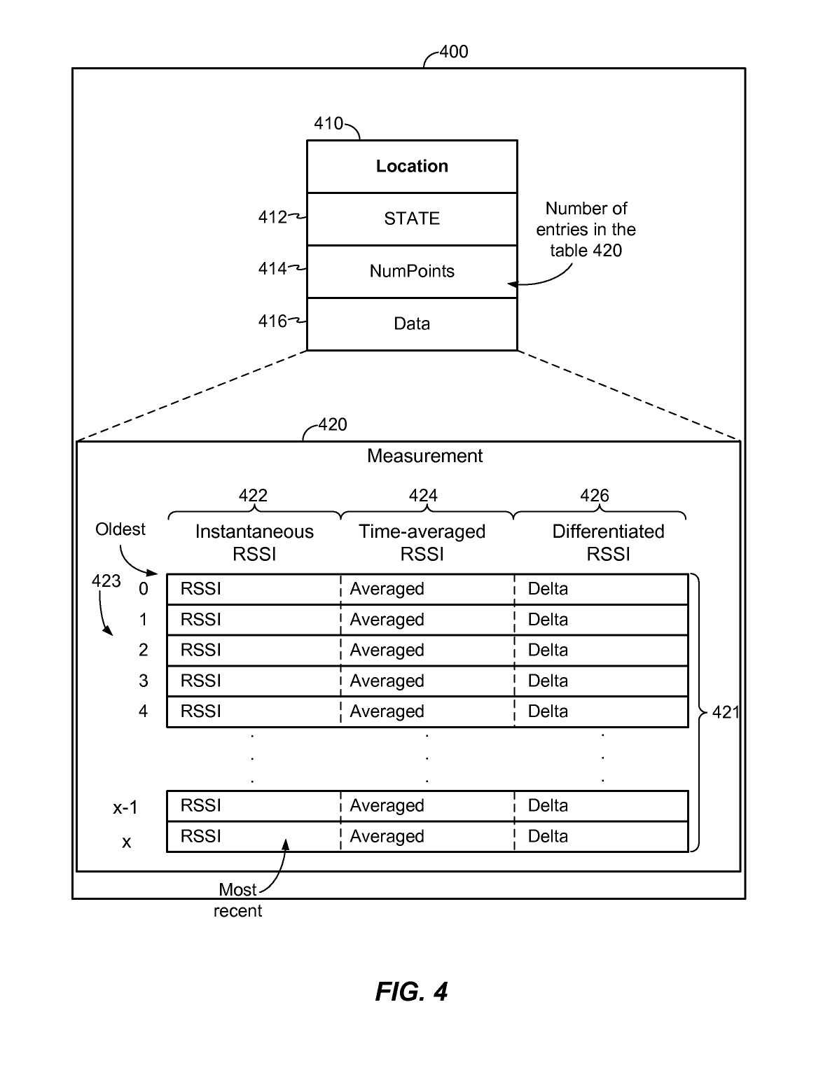

FIG. 4 is an example of a data structure for the system for determining range in a wireless system. In an exemplary embodiment in which the beacon device 200 is running the ranging module 265 to determine the range or distance between the beacon device 200 and the wireless device 300, the data structure 400 may be created by the ranging module 265 and maintained in the storage element 203. In an exemplary embodiment, the data structure 400 comprises a location component 410 and a measurement component 420. The location component 410 comprises a “State” element 412, which corresponds to the current distance state category the wireless device 300 is considered to be in relative to the beacon device 200 (e.g., “near”, “medium” “far”, etc.). The location component 410 also comprises a “NumPoints” element 414 which corresponds to the integral number of data points stored as entries in a table 421 in the measurement component 420 relating to the range between the wireless device 300 and the beacon device 200; and a “Data” array element 416, which contains the measurement component 420. In an exemplary embodiment, the measurement component 420 comprises a table 421 having rows 423 and columns 422, 424 and 426 containing a list of RSSI measurements and computations conducted by the beacon device 200 relative to the location of the wireless device 300. Each row 423 corresponds to a point in time at which an instantaneous RSSI measurement can be taken and, if determined to be appropriate, computations made using instantaneous RSSI measurements taken over a number of points in time. The point in time at which an instantaneous RSSI measurement is taken and saved may also be referred to as a “sample” or a “sample time.” Each instantaneous RSSI measurement is saved in a row 423 at a unique sample time.

In an exemplary embodiment, the measurement component 420 stores the table 421 comprising one or more RSSI measurements and computations. In an exemplary embodiment, the table 421 includes a column 422 having measurements for “instantaneous RSSI”, which corresponds to the RSSI in dB measured by the beacon device 200 between the wireless device 300 and the beacon device 200; a column 424 having a computation for “time-averaged RSSI”, which corresponds to a time-averaged RSSI measurement of the “instantaneous RSSI” measurements in the column 422 between the wireless device 300 and the beacon device 200; and a column 426 having a computation for “differentiated RSSI” also referred to as a “delta”, which corresponds to the difference between multiple time-averaged RSSI computations obtained between the wireless device 300 and the beacon device 200. In an exemplary embodiment, the table 421 comprises rows 423, each row having a location for a possible entry for one or more of the instantaneous RSSI in column 422, the time-averaged RSSI in column 424 and the differentiated RSSI in column 426. In the example shown in FIG. 4, the table 421 includes rows labeled “0” through “x”, with the row labeled “x” being the most recent sample time, the row labeled “x−1” being the next most recent sample time, and the row labeled “0” being the oldest sample time. For example, if the table 421 comprises ten instantaneous RSSI entries in the column 422, from entry “0” through “9” the value in the NumPoints element 414 will be 10, but the 10^{th} entry in the table 421 will show an index of 9 because the first entry will be in row “0” of the table 421. The entries in the table 421 are saved in the storage element 203. The numerical value contained in the NumPoints element 414 will be x+1 because in this example for ten entries in the table 421, x=9, so NumPoints=10.

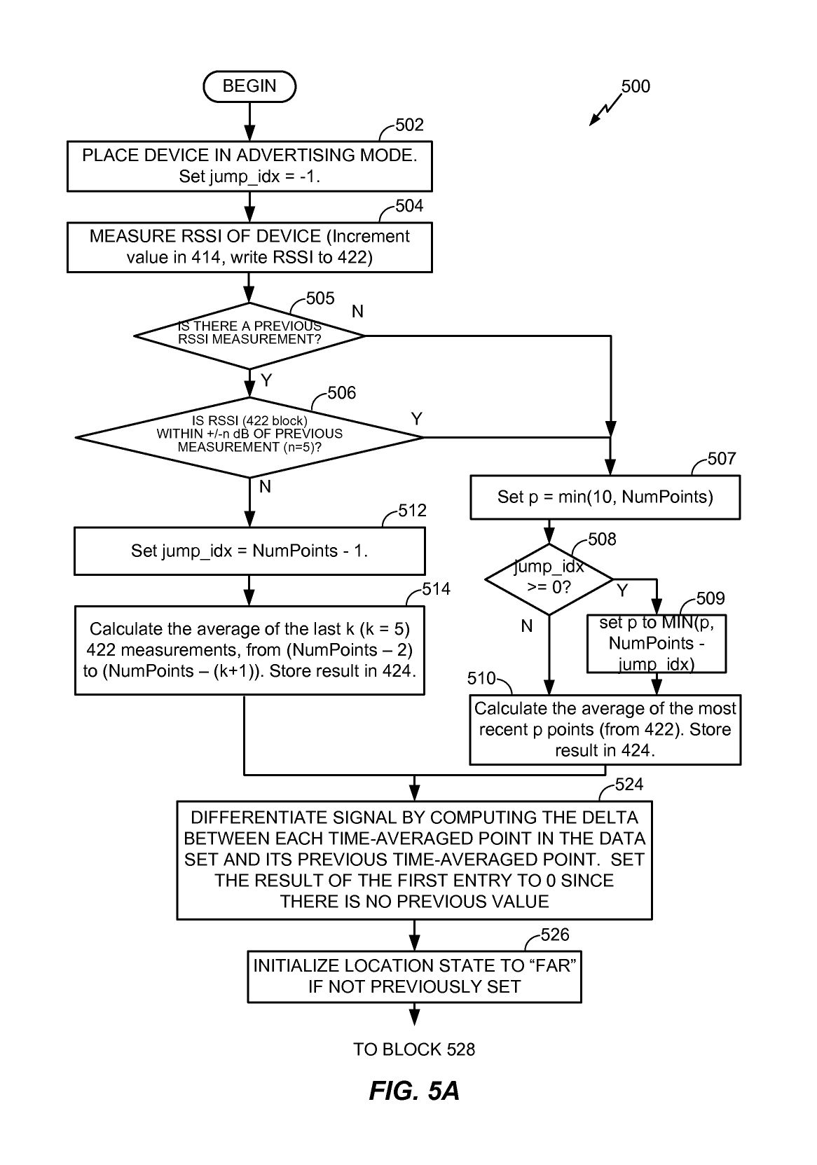

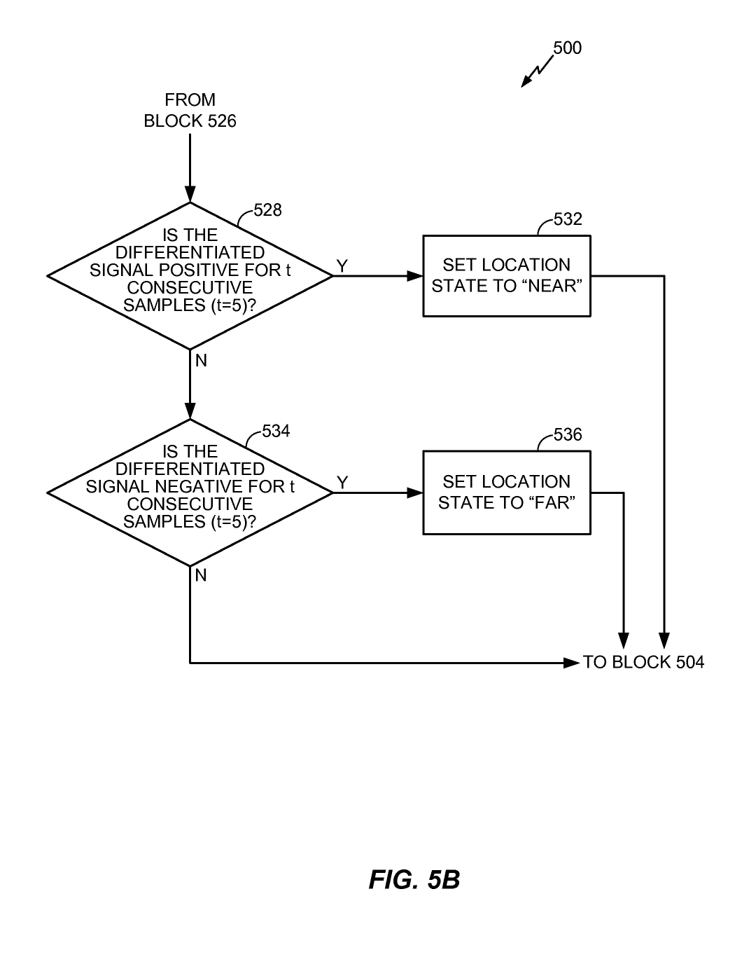

FIGS. 5A and 5B are a flow chart collectively illustrating an exemplary embodiment of a method for determining range in a wireless system. The method described in FIGS. 5A and 5B can be performed by an instance of the ranging module located on a beacon device (such as beacon device 110 of FIG. 1 or beacon device 200 of FIG. 2), or can be performed by an instance of the ranging module located on a wireless device (such as the user device 150 of FIG. 1 or the wireless device 300 of FIG. 3). The blocks in the flow chart 500 can be performed in or out of the order shown.

In block 502, the wireless device 300 is placed in what can be referred to as an “advertising” mode in which the wireless device 300 transmits a signal identifying its presence to any beacon devices 200 that may be within wireless communication range. An index, referred to as a “jump index” or “jump_idx” is set to a value of −1. The jump index refers to a numerical value in the “NumPoints” element 414 in FIG. 4. The numerical value in the NumPoints element 414 refers to the integral number of data points stored as sample time entries in the rows 423 of the table 421. Each data point refers to an entry in a row 423, each entry occurring at a particular unique sample time. As will be described below, the jump index value refers to the number of data points (samples) that occur between changes in RSSI measurement that exceed a predetermined threshold. In an exemplary embodiment, this threshold can be an integer number of dB, and in an exemplary embodiment, can be 5 dB, such that the jump index value does not change until there is a change in instantaneous RSSI that exceeds 5 dB between two instantaneous RSSI measurements in this example.

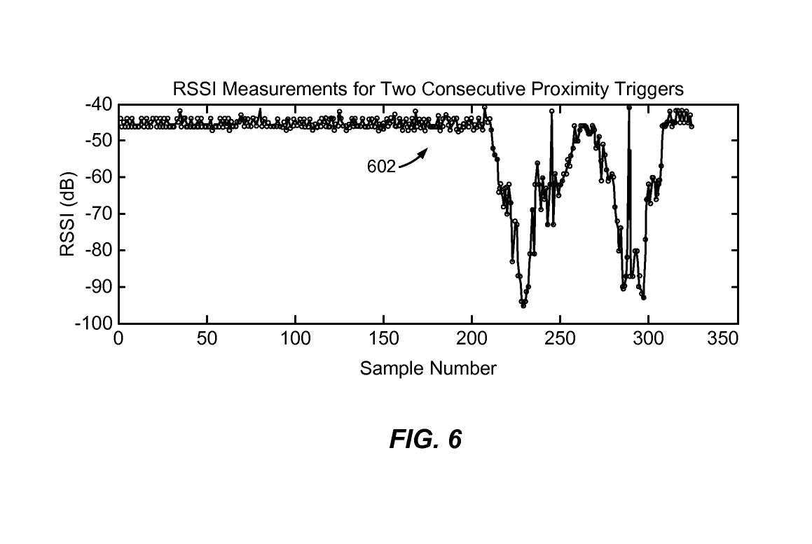

In block 504, the beacon device 200 receives the advertising signal from the wireless device 300 and measures the instantaneous RSSI of the wireless device 300. In an exemplary embodiment, the instantaneous RSSI measurement is saved in the table 421 in the first location for instantaneous RSSI 422 in row 0. FIG. 6 shows an exemplary embodiment of a waveform 602 generated by a BLE device entering and leaving proximity of a tablet device twice, with samples collected every 640 ms. A first occurrence of a BLE device entering and leaving proximity of a tablet device is shown from approximately sample 210 to approximately sample 240, and a second occurrence of the BLE device entering and leaving proximity of a tablet device is shown from approximately sample 290 to approximately sample 310. From this it is evident that there is not a direct mapping to go from RSSI signal strength to distance measurements or distance categories.

In block 505, it is determined whether there is a previous instantaneous RSSI measurement, i.e., whether there is an instantaneous RSSI measurement in the table 421. If there is no previous instantaneous RSSI measurement in the table 421, then it is determined that the instantaneous RSSI measurement is the first instantaneous RSSI measurement, and the process proceeds to block 507. If it is determined in block 505 that there is a previous instantaneous RSSI measurement, i.e., there is already at least one instantaneous RSSI measurement in the table 421, then the process proceeds to block 506.

In block 506, it is determined whether the instantaneous RSSI measured in block 504 is within +/−n dB of a previous measurement saved in the “instantaneous RSSI” column 422 in the table 421. In an exemplary embodiment, n=5 but n may be any other suitable number.

If it is determined in block 506 that the instantaneous RSSI measured in block 504 is within +/−n dB of the previous measurement in the “instantaneous RSSI” column 422, or if it was determined in block 505 that the instantaneous RSSI measured in block 504 is the first RSSI measurement, then, in block 507, a variable, “p”, which refers to the number of measurements in the instantaneous RSSI column 422 that will be used to compute the time-averaged RSSI, is set to a value of the actual number of instantaneous RSSI measurements in the column 422 (i.e., the numerical value in the NumPoints element 414), or to a value of 10, whichever is smaller. The variable “p” determines the number of instantaneous RSSI samples that will be used to calculate the time-averaged RSSI for each sample time. In this example, “p” is set to a maximum of 10 samples, but “p” can be any number equal to or greater than 1. In this example, “p” is set so that no more than 10 samples are included in the average because measurements that were obtained very long ago (i.e., longer than 10 sample times ago in this example) are not very relevant. While “p” is set to a maximum of 10 sample times, “p” can be any number.

In block 508, it is determined whether the value in the jump index is greater than or equal to zero. If there has been a jump in instantaneous RSSI that exceeds the threshold (5 dB in this example) in the last p samples, then it is desired to exclude from the time-averaged RSSI computation the values of instantaneous RSSI occurring before the jump in instantaneous RSSI because including those sample values would skew the average away from the actual measurements (e.g., a −10 dB measurement one measurement ago and a −50 dB measurement two measurements ago average to −30 dB, but the value −30 dB was never actually obtained). Because the jump index is initialized at a value of −1 in block 502, the value of the jump index being nonnegative indicates that block 512 has been reached by a previous iteration of the execution of the flow chart 500. Checking the value of the jump index ensures that only samples that are reasonably similar in signal strength, i.e., all samples within 5 dB in this example, are averaged.

If it is determined in block 508 that the jump index is not greater than or equal to zero, then there was no jump in instantaneous RSSI exceeding the 5 dB threshold over the last “p” samples and the process proceeds to block 510, where the average of the most recent “p” samples is computed and stored as the time-averaged RSSI entry in column 424 for the selected row 423.

If it is determined in block 508 that the jump index is greater than or equal to zero, then, at some point, there was a jump in instantaneous RSSI greater than the 5 dB threshold, so all of those instantaneous RSSI samples before the jump in RSSI should not be included in the time-averaged RSSI computation. In block 509 the number of “p” samples is determined In an embodiment, the value of “p” is set according to MIN(p, NumPoints−jump_idx). The difference (NumPoints−jump_idx) is calculated to determine the number of measurements taken since the last jump in RSSI that exceeds the threshold. If that jump in instantaneous RSSI occurred more than “p” sample times ago, then the last “p” samples are averaged. If the jump in instantaneous RSSI occurred within the last “p” sample times, then the value of “p” is adjusted to remove the measurements that occurred before the 5 dB jump in instantaneous RSSI. In block 510, the value for “p” determined in block 509 is used and the average of the most recent “p” instantaneous RSSI entries in the column 422 is calculated and the result is stored as the averaged RSSI entry in the column 424 for the selected row.

If it is determined in block 506 that the instantaneous RSSI is not within +/−n dB of a previous measurement, then, in block 512, the jump index is set to a value corresponding to NumPoints−1. Setting the jump index to the value corresponding to NumPoints−1 ensures that the number of entries in the instantaneous RSSI column 422 that are averaged in block 514 do not exceed the number of instantaneous RSSI values since a jump in RSSI that exceeds +/−n dB, where n=5 in this example.

In block 514, in an exemplary embodiment, the average of the previous “k” measurements, from (NumPoints−2) to (NumPoints−(k+1)) are the number of measurements used to compute the time-averaged RSSI value. In this exemplary embodiment, the range of points in the average should contain 5 points and exclude the most recent entry and “k” refers to the number of entries that are being calculated, where in this example, k=5, but k can be any number. In an exemplary embodiment, the average of the last k measurement values is stored as the averaged RSSI in column 424 for the selected row.

In block 524 a difference, or “delta” is computed between each time-averaged RSSI entry and its previous time-averaged RSSI entry in the column 424. For example, a difference is computed between the NumPoints−1 entry in the column 424 and the NumPoints−2 entry in the column 424. This “delta” is stored in the differentiated RSSI column 426 for the NumPoints−1 row in this example. If this is the first “differentiated RSSI” entry in the column 426, then the results for the first entry are set to zero because there is no previous value to set.

In block 526, in an example in which three exemplary distance categories, “near” “medium” and “far” are used, the location setting is initialized to “far” if not previously set.

In block 528, it is determined whether the differentiated signal is positive for t consecutive samples, where t=5, but t can be any other suitable number.

If, in block 528, it is determined that the differentiated signal is positive for t consecutive samples, then, in block 532, the location is set to “near.”

If, in block 528, it is determined that the differentiated signal is not positive for t consecutive samples, then, in block 534 it is determined whether the differentiated signal is negative for t consecutive samples, where t=5.

If, in block 534, it is determined that the differentiated signal is negative for t consecutive samples, then, in block 536, the location is set to “far.”

The process then returns to block 504.

The process continues as long as up-to-date ranging information is desired. Either the beacon device 200 or the wireless device 300 may end the procedure by stopping advertising or stopping measuring.

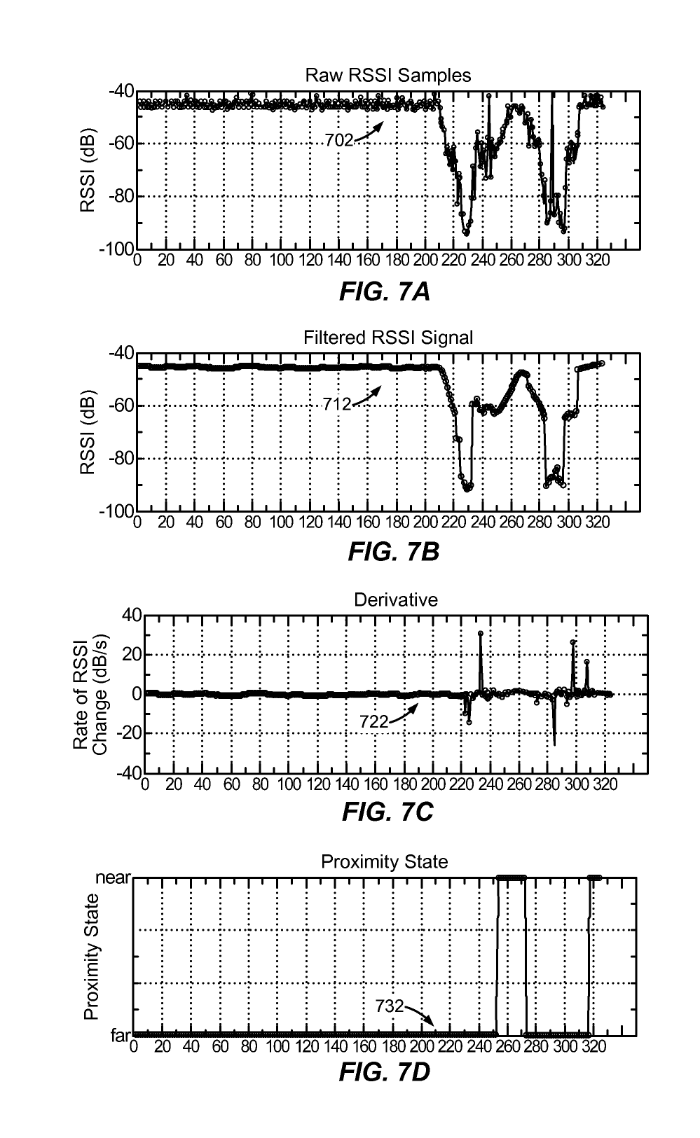

FIGS. 7A, 7B, 7C and 7D are graphs illustrating the processing of RSSI measurements for a user device to obtain range information.

FIG. 7A shows a raw RSSI signal having data points collected over a period of time. In an exemplary embodiment, 320 samples are collected every 640 ms. The signal 702 in FIG. 7A is similar to the signal 602 in FIG. 6. From about sample 0 to about sample 210, the RSSI remains relatively constant, so determining relative position between the beacon device 200 and the wireless device 300 is difficult to determine Although shown in FIG. 7A as a relatively “strong” RSSI signal level of approximately −40 dB, this was arbitrarily assigned as the “far” category (FIG. 7D) because of an exemplary use case. In an exemplary use case, a beacon device 200 is always on, so a ramp from “far” to “near” is expected. However, the example shown in FIGS. 7A through 7D starts with the two devices starting close together. This exemplary embodiment differs from an intended use case but is shown for illustrative purposes only. From sample 0 through about sample 210 the RSSI signal is relatively strong and steady, indicating that the beacon device 200 is relatively close to the wireless device 300, and that there is little or no change in relative position between the beacon device 200 and the wireless device 300. From about sample 210 to about sample 230 the RSSI signal is getting weaker, indicating that the beacon device 200 and the wireless device 300 are moving away from each other. From about sample 230 to about sample 275, the RSSI signal is getting stronger, indicating that the beacon device 200 is moving mostly linearly toward the wireless device 300, but the signal is noisy indicated by the signal level spikes and drops. From about sample 275 to about sample 310, the RSSI signal is getting weaker (except for the spike due to noise at about sample 290), indicating that the beacon device 200 is moving away from the wireless device 300.

FIG. 7B shows the signal 702 of FIG. 7A after filtering, corresponding to blocks 508 and 512 in FIG. 5A. The filtered signal 712 represents filtered RSSI samples and results in the substantial elimination of the spikes and drops present in signal 702.

FIG. 7C shows a signal 722 representing a derivative of the waveform of the signal 712 in FIG. 7B after the signal 712 is differentiated.

FIG. 7D shows a signal 732 representing the waveform of FIG. 7C after the ranging module (265, FIG. 2) assigns proximity states as described above. While only two proximity states, near and far, are shown in FIG. 7D, any number of proximity states can be implemented. As mentioned above, the initial proximity state shown in FIG. 7D is considered “far” even though in this example, the beacon device 200 and the wireless device 300 are physically near to each other at sample 0 indicated by the relatively strong approximate -40 dB RSSI signal level shown in FIG. 7A. In an exemplary embodiment in which the beacon device 200 and the wireless device 300 are relatively far from each other at the beginning of the process, the RSSI would indicate a relatively “weak” signal strength from sample 0 through about sample 210.

The ranging module (265, FIG. 2) analyzes the RSSI to determine rate of change information so it can be predicted when a distance category boundary is about to be crossed. This information is useful in retail environments, for example, to perform some action when a customer is about to exit the store.

In an exemplary embodiment, no prior configuration information is needed to configure the ranging module with predefined thresholds, time to trigger, or hysteresis readings. The ranging module uses collected samples to determine when changes have occurred.

The following example makes reference to FIGS. 5A and 5B and FIGS. 7A through 7D. In an exemplary embodiment using a classroom environment, assume that every student in a class has a Bluetooth-enabled tablet (i.e., beacon devices, FIG. 2), and that the teacher also has a Bluetooth-enabled tablet (i.e., a wireless device, FIG. 3). An application on the teacher's tablet can be adapted to track attendance and could be coupled to or integrated with an instance of the ranging module 365 on the teacher's tablet. The attendance application could keep track of the time when students enter the classroom by receiving information from the ranging module regarding tracking student proximity to the teacher's wireless device and could automatically generate attendance lists. However, if the student just enters the class and leaves, the attendance application shouldn't give them credit for attending. So, it's desirable to track location state.

Corresponding to blocks 502 and 504, the teacher's tablet starts measuring signal strength (RSSI) from student tablets. The teacher's tablet is powered on before the students start entering the classroom.

Corresponding to blocks 505, 506, 507, 508, 509, 510 and 512, as students enter the class, the teacher's tablet will see a change (increase) in the relative strength of the RSSI signal. The averaging process of blocks 505, 506, 507, 508, 509, 510 and 512 filters out RF noise, which is evident when comparing the raw RSSI samples of the signal 702 of FIG. 7A to the filtered waveform signal 712 of FIG. 7B, and stores the time-averaged RSSI measurements in column 424 of the table 421.

Corresponding to block 524, the ranging module 365 in the teacher's tablet differentiates the filtered signal to identify changes in state. Note that the raw RSSI level is not of interest but knowing when the RSSI signal value changes significantly is of interest and is used as a determination of state. Compare the filtered signal 712 of FIG. 7B to the derivative signal 722 shown in FIG. 7C.

Corresponding to blocks 526, 528 and 534, the signal 722 representing the derivative in FIG. 7C is monitored over time to determine when the student's position changes state (e.g. “out of class” to “in class”)

After the entire procedure in FIGS. 5A and 5B is completed, the resulting signal 732 in FIG. 7D represents an accurate indicator of when the student entered and left class. Beginning with the raw RSSI sample signal 702 of FIG. 7A, the teacher's tablet can determine when the student entered and left class. This information is not obvious in FIG. 7A directly because of the spikes in the signal 702 due to noise, interference, other signal anomalies, etc.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method, comprising:
obtaining a received signal strength indication; and
processing the received signal strength indication to determine a range between a first device and a second device free of prior configuration data between the first device and the second device.

2. The method of claim 1, wherein processing the received signal strength indication comprises:
obtaining a plurality of signal strength indication samples;
filtering the plurality of signal strength indication samples;
obtaining a derivative of the plurality of signal strength indication samples; and
categorizing the derivative of the plurality of signal strength indication samples into at least one of a plurality of proximity states.

3. The method of claim 2, wherein the plurality of proximity states comprises near, medium and far proximity states.

4. The method of claim 2, wherein a state change from a first proximity state to a second proximity state occurs after a predefined change in the signal strength of the signal strength indication samples.

5. The method of claim 2, wherein the first device and the second device communicate over a Bluetooth communication channel.

6. The method of claim 2, wherein the first device and the second device communicate over a WIFI communication channel.

7. The method of claim 2, further comprising using the plurality of proximity states to determine whether the first device and the second device are approaching one another.

8. The method of claim 2, further comprising using the plurality of proximity states to determine whether the first device and the second device are moving away from one another.

9. A device, comprising:
a receiver configured to generate a received signal strength indication; and
a ranging module configured to process the received signal strength indication to determine a range between a first device and a second device free of prior configuration data between the first device and the second device.

10. The device of claim 9, wherein the ranging module is configured to:
obtain a plurality of signal strength indication samples;
filter the plurality of signal strength indication samples;
obtain a derivative of the plurality of signal strength indication samples; and
categorize the derivative of the plurality of signal strength indication samples into at least one of a plurality of proximity states.

11. The device of claim 10, wherein the plurality of proximity states comprises near, medium and far proximity states.

12. The device of claim 10, wherein a state change from a first proximity state to a second proximity state occurs after a predefined change in the signal strength of the signal strength indication samples.

13. The device of claim 10, wherein the first device and the second device communicate over a Bluetooth communication channel.

14. The device of claim 10, wherein the first device and the second device communicate over a WIFI communication channel.

15. The device of claim 10, further comprising using the plurality of proximity states to determine whether the first device and the second device are approaching one another.

16. The device of claim 10, further comprising using the plurality of proximity states to determine whether the first device and the second device are moving away from one another.

17. A system, comprising:
means for obtaining a received signal strength indication; and
means for processing the received signal strength indication to determine a range between a first device and a second device free of prior configuration data between the first device and the second device.

18. The system of claim 17, further comprising:
means for obtaining a plurality of signal strength indication samples;
means for filtering the plurality of signal strength indication samples;
means for obtaining a derivative of the plurality of signal strength indication samples; and
means for categorizing the derivative of the plurality of signal strength indication samples into at least one of a plurality of proximity states.

19. The system of claim 17, wherein the plurality of proximity states comprises near, medium and far proximity states.

20. The system of claim 17, further comprising using the plurality of proximity states to determine whether the first device and the second device are approaching one another or moving away from one another.
